(19) United States
(12) Patent Application Publication
(10) Pub. No.: US 2005/0155698 A1
(43) Pub. Date: Jul. 21, 2005

(54) Method of manufacturing a polymeric foil

(75) Inventors: Johannes Marra, Eindhoven (NL); Pierre Cobben, Nijmegen (NL); Joanna Baken, Eindhoven (NL); Gerardus Van Gorkom, Eindhoven (NL); Henricus Josephus Kunnen, Valkenswaard (NL); Peter Duine, Eindhoven (NL)

Correspondence Address: Philips Electronics North America Corporation;Corporate Patent Counsel, PO Box 3001, Briarcliff Manor, NY, 10510, US

(73) Assignee: Koninklijke Philips Electronis N.V., 5621 BA Eindhoven (NL)

(21) Appl. No.: 10/504,242

(22) PCT Filed: Jan. 29, 2003
(86) PCT No.: PCT/IB03/00271

(30) Foreign Application Priority Data
Feb. 13, 2002 (EP) 020755898

(51) Int. Cl. B44C 1/165; C09J 1/00

(52) U.S. Cl. 156/230; 156/247

(57) ABSTRACT

Applying the method of manufacturing a polymeric foil (30) having partly embedded inorganic particles (19) results in the polymeric foil (30) being suitable for use as a movable element (3) in a display panel (21). The method starts by embedding inorganic particles (19) partly into a release layer (32) which covers a substrate (31). This product (37) is covered with a layer of polymeric material (18), which is solidified to obtain the polymeric foil (30). By removing the release layer (32), the polymeric foil (30) having a surface with a roughness brought about by the partly embedded inorganic particles (19) is set free.

The invention relates to a method of manufacturing a polymeric foil having partly embedded inorganic particles, the polymeric foil being suitable for use as a movable element in a display panel.

A display panel having such a polymeric foil is known from PHNL010908EPP. The known display panel comprises a light guide plate in which, in operation, light is generated and trapped so that this first plate forms a light guide, a second plate and, between said two plates, a movable element. By applying voltages to electrodes on the light guide plate and the second plate, and to the movable element, which is made from conductive material or contains a conductive layer, the movable element is locally brought into contact with the light guide plate or the second plate. At locations where the movable element is in contact with the light guide plate, light is coupled out of the light guide plate. A roughness brought about by partly embedded inorganic particles, hereinafter also called inorganic protrusions, is present at the surface of the movable element facing the light guide plate for contacting the light guide plate. The display panel requires relatively little energy to interrupt the physical contact between the movable element and the light guide plate by applying voltages to the electrodes and the movable element, while good optical contact can still be provided between the movable element and the light guide plate.

For the production of the known display panel on an industrial scale, there is a need for the polymeric foil in relatively large amounts. Experiments have been carried out to find a manufacturing method that is applicable on an industrial scale. In an experiment a dispersion of inorganic particles in a solution containing a solvent and a polymeric solute was applied as a polymer/particle/solvent layer to a substrate, after which the solvent was removed. Then the resulting polymeric foil was removed from the substrate. The polymeric foil had a roughness at the surface facing the substrate comparable to the roughness of the surface of the substrate facing the polymeric foil, but contained hardly any inorganic protrusions at the surface. In another experiment, where a solution containing a solvent and a polymeric solute was applied as a polymer/solvent layer to a substrate, inorganic particles were deposited on top of the solvent/solute layer while removing the solvent from this layer. The resulting polymeric foil contained more inorganic protrusions at the surface facing away from the substrate. However, the reproducibility of the distribution of the inorganic protrusions at the surface and the adjustability of the surface roughness by the method of manufacturing were low.

A drawback of these methods of manufacturing a polymeric foil is that in this way it is difficult to manufacture the polymeric foil with a reproducible distribution of the inorganic protrusions at the surface of the polymeric foil, and with a surface roughness that is relatively well adjustable. Therefore these methods are little suitable for the production of the polymeric foil on an industrial scale.

It is an object of the invention to provide a method of manufacturing a polymeric foil of the type mentioned in the opening paragraph, which is applicable on an industrial scale.

The object is achieved by the method comprising the steps of
a) embedding inorganic particles partly into a release layer which covers a substrate, thereby obtaining a product having a rough surface,
b) covering the product with a layer of polymeric material, thereby partially embedding the inorganic particles within the layer of polymeric material,
c) solidifying the layer of polymeric material to obtain the polymeric foil, and
d) removing the release layer to set free the polymeric foil having a surface with a roughness brought about by the partly embedded inorganic particles.

The inventors have realized that the process of making the inorganic protrusions has to take place in one or more well controllable steps. For this purpose a release layer is used, in which inorganic particles can be partly embedded. The process of embedding the inorganic particles partly into the release layer is well controllable by choosing the diameter of the inorganic particles to be such that it is larger than the thickness of the release layer, and by choosing the release layer material such that the inorganic particles are embedded into the release layer when the release layer exists in, or is brought into, a relatively soft viscous state. The inorganic particles are embedded in the release layer until they are at rest at the interface between the release layer and the substrate. The resulting product has a rough surface, which is subsequently covered with a layer of polymeric material. The inorganic particles that are partly embedded in the release layer are also partly embedded in the layer of polymeric material. By subsequently solidifying the layer of polymeric material, the polymeric foil is obtained. The inorganic particles are partially embedded in the solidified polymeric material. After removal of the release layer, the inorganic particles are still partially embedded and thus trapped in the polymeric material: the polymeric foil is set free from the substrate and has a surface with a roughness brought about by the organic particles partly embedded therein. The surface roughness can be controlled by the thickness of the release layer, the diameter of the inorganic particles and the surface number density of the inorganic particles in direct contact with the release layer and by controlling the step of embedding the inorganic particles partly into the release layer.

In this way a polymeric foil is manufactured with a reproducible distribution of the inorganic protrusions at the surface of the polymeric foil and with a surface roughness that is relatively well adjustable. Therefore this method is applicable for production of the polymeric foil on an industrial scale.

It is important that, when the inorganic particles contact the release layer, the release layer used is brought into a relatively soft viscous state for embedding inorganic particles partly into the release layer. If the release layer is not already in a relatively soft viscous state it has to be brought into that state. For example, the release layer is brought into a relatively soft viscous state by raising the temperature of the release layer above a softening temperature of the release layer. Alternatively, the release layer is brought into a relatively soft viscous state by bringing the release layer into contact with a material that is a solvent for the release layer, for example if the release layer used contains organic material. In a particular example, the release layer used contains water-soluble organic material. Furthermore, use of a release layer containing water-soluble organic material has the advantage that the step of removing the release layer to release the polymeric foil from the substrate can be performed by dissolving the release layer in water. In a preferred embodiment the release layer is brought into a relatively soft viscous state by exposure of the release layer to moist air. This is attained in a controllable way by exposing the release layer during a controlled period of time to a controlled high-humidity environment wherein the relative humidity is in the 80%-100% range. The water vapor softens the release layer for embedding the inorganic particles partly into the release layer. The inorganic particles remain partly embedded in the release layer after removal of the product from the high-humidity environment. In an even more preferred embodiment the release layer used contains polyvinyl alcohol. Polyvinyl alcohol is a versatile water-soluble organic material available in a wide variety of molecular weights and chemical compositions and is an excellent film former. It can be readily deposited as a polyvinyl alcohol/water film in a variety of thicknesses across the substrate, e.g. by spin coating of a polyvinyl alcohol solution in water across the substrate, and forms a hard release layer when the water is removed from the cast film. A polyvinyl alcohol release layer softens when exposed to a relatively high-humidity environment and is environmentally friendly.

A wide range of dimensions of the inorganic particles is possible. Inorganic particles having a diameter smaller than the thickness of the release layer can penetrate completely into the release layer during the embedding process. They will not add to the surface roughness of the polymeric foil as they will not become partly embedded into the polymeric foil, and they are removed when the release layer is removed to set free the polymeric foil. The combination of the release layer used having a thickness between 5 and 100 mm, and the inorganic particles used having a diameter larger than the thickness of the release layer results in a polymeric foil with a surface roughness in the range in between 5 and 100 nm brought about by inorganic protrusions. This is the preferred range for the roughness of the surface of the polymeric foil facing the light guide plate. The inorganic protrusions do not readily undergo elastic and/or plastic deformations when the movable element is in contact with the light guide plate. The roughness is large enough to substantially reduce the adhesive Van der Waals' forces, resulting in a display panel requiring relatively little energy to interrupt the contact between the light guide plate and the movable element. On the other hand, the surface roughness is small enough to ensure that light can be satisfactorily coupled out of the light guide plate and coupled into the polymeric foil. In a preferred embodiment inorganic particles used have a diameter between 100 and 1000 nm. The obtained polymeric foil has a surface roughness in the preferred range whereas the inorganic particles have dimensions which are smaller than the thickness of the polymeric foil, which is generally in the range between one and two micrometers. Inorganic particles can also be fully embedded within the bulk of the polymeric foil. In that case, these particles are referred to as scattering particles: these particles are present to scatter light out of the polymeric foil. It is even possible that the inorganic particles representing the scattering particles are of a different size or material than the inorganic particles forming the inorganic protrusions. In that case, step b) is extended with an extra deposition step of the other type of inorganic particles.

In step a) the inorganic particles are deposited on the release layer. This deposition can be performed in several ways, for instance the inorganic particles are deposited on the release layer as a particle/solvent film using a wet coating technique, such as spin coating, dip coating, spray coating, or curtain coating of a liquid-based inorganic particle dispersion across the release layer. The inorganic particles take the form of an inorganic particle layer on the release layer following the removal of the solvent from the particle/solvent film. Alternatively, in step a) the inorganic particles are deposited from an aerosol phase. Then the inorganic particles are blown as aerosolized particles in air towards a release layer. Inorganic particle deposition from an aerosol phase is an environmentally friendly process step and allows a relatively good homogeneity of the deposited inorganic particle layer to be attained across the release layer surface. The characteristics of an aerosol deposition step involve the dispersion of a particle powder in air, hereinafter referred to as a particle aerosol, and the classification of the particle aerosol into particles having a diameter that falls within a desired range. For obtaining a particularly homogeneous distribution of inorganic particles across the release layer, in step a) the inorganic particles are preferably deposited from an aerosol phase by using gravity deposition or electrostatic deposition. Gravity deposition of inorganic particles on the release layer is obtained by allowing the classified inorganic particle aerosol to be homogeneously present throughout the volume of a settling chamber and to settle from the aerosol phase onto the release layer during a controlled period of time under the influence of the force of gravity acting on the aerosolized inorganic particles. Electrostatic deposition of inorganic particles on the release layer involves the electrostatic charging of the classified inorganic particle aerosol through either a corona charging step or a tribo charging step or a mixed corona/tribo charging step, the transport of the charged inorganic particle aerosol towards the release layer, and the electrostatic deposition of the charged inorganic particle aerosol onto the release layer under the influence of an electrostatic potential difference between an electrode and the substrate. A defined electrostatic potential can be imposed on the substrate when the substrate used has a conductive layer or when a conductive layer is present in close proximity to the substrate at the side of the substrate facing away from the release layer.

The deposition of inorganic particles from an aerosol phase onto a release layer frequently results in an inorganic particle layer characterized by an open fractal-like inter-particle structure possessing a large porosity and a small particle volume fraction. The volume fraction of the inorganic particle layer on the release layer is increased if between step a) and step b) the product is immersed in and subsequently withdrawn from a liquid for increasing the volume fraction of the inorganic particles on the release layer. This dipping process involves the immersion of the product into a dipping liquid followed by the withdrawal of the product from the dipping liquid. For the dipping liquid use is preferably made of a liquid that is a non-solvent for the release layer material and that wets the deposited inorganic particles. An example of a preferred dipping liquid is heptane if the release layer material is polyvinyl alcohol and the inorganic particles are TiO₂.

In step b) the product can e.g. be covered with a polymeric material by using a wet coating method such as spin coating, dip coating, spray coating or curtain coating the polymeric material being dissolved or dispersed in a solvent. The wet coating method initially covers the product with a polymer/solvent film. Solidifying the polymeric material in step c) occurs during removal of the solvent from the polymer/solvent film. An additional annealing step or curing step at a high temperature may be necessary or desirable to further improve the solidification of the polymeric material. Alternatively, in step b) the product can be covered with a polymeric material such as parylene using a solvent-free vapor deposition polymerization of parylene monomers, for example according to the Gorham process. Polymerization and solidification of the parylene layer occurs simultaneously with the deposition of the parylene monomers on the product.

The solidified polymeric material exists either in a glassy amorphous state or in a crystalline state or in a mixed glassy amorphous/crystalline state, for example, to give the solidified polymeric material a stiffness similar to that of a crystalline organic material. These materials are not readily subject to plastic deformation and/or creep.

To apply a voltage to the polymeric foil, the polymeric foil must have conductive properties. These are provided if the polymeric material is a good conductor. If the polymeric material is not a good conductor, such as for example parylene, polymethylmethacrylate, some fluoropolymers and polyimide, in the method of manufacturing the polymeric foil an additional step is performed in which the product and/or the polymeric foil is covered with a conductive layer prior to performing step d). This additional process step results in three different polymeric foils. If the product is covered with a conductive layer prior to performing step d), the polymeric foil used as a movable element has the conductive layer at the surface facing the light guide plate. If the polymeric foil is covered with a conductive layer prior to performing step d), the polymeric foil used as a movable element has the conductive layer at the surface facing the second plate. If the product is covered with a first conductive layer and the polymeric foil is covered with a second conductive layer prior to performing step d), the polymeric foil used as a movable element has a first conductive layer at the side facing the light guide plate and a second conductive layer at the side facing the second plate. Alternatively, the polymeric foil can be covered with conductive layers on one or on both sides after the foil is set free from the substrate. Due to the conductive layer or layers, the polymeric foil contains an electrode for applying voltages. An advantage of having conductive layers on both sides of the polymeric foil is that a single potential can be applied to both conductive layers, which results in a polymeric foil potential that is uniformly present throughout the entire polymeric foil volume. This uniform potential prohibits the development of static charge formation on the polymeric foil surface or within the polymeric foil. The conductive layers are preferably optically transparent and inorganic in nature. An example of a preferred conductive layer is an indium-tin-oxide layer.

In the method of manufacturing the polymeric foil an additional step may be performed in which the product and/or the polymeric foil is covered with an inorganic layer prior to performing step d). Alternatively, the polymeric foil can be covered with an inorganic layer on the side facing the light guide plate and/or on the side facing the second plate after the polymeric foil is set free from the substrate. The advantage of having an inorganic layer on one side or on both sides of the polymeric foil is that the inorganic layer increases the stiffness and wear resistance of the polymeric foil surface. An increased stiffness of the polymeric foil surface counteracts creep and visco-elastic and/or plastic deformations of the polymeric foil surface, which is desirable to diminish the chance of strong adhesive forces from ever occurring between the polymeric foil and the light guide plate or between the polymeric foil and the second plate. An increased wear resistance gives protection against possible gradually occurring damage to the polymeric foil surface when the polymeric foil is used as a movable element in a display panel.

A roughness of the surface of the polymeric foil facing the second plate in the range between 100 and 1000 nm results in a display panel requiring relatively little energy to interrupt the contact between the second plate and the movable element. However, after performing step c) and prior to performing step d) the roughness of the polymeric foil can fall outside this range. For this reason, the polymeric foil has a free surface facing away from the release layer, which surface is treated to adjust the surface roughness so as to be within a range between 100 and 1000 nm prior to performing step d). This surface treatment can be a smoothing or roughening step, for instance through chemical etching, polishing or rubbing. Another treatment that smoothens the second surface of the polymeric foil involves spin coating or dip coating of a polymer/solvent film across the polymeric foil from a polymer solution followed by solvent removal. In this way, the roughness of the second surface of the polymeric foil facing the second plate can be adjusted so as to be in said range.

These and other aspects of the invention will be further elucidated and described with reference to the drawings, in which:

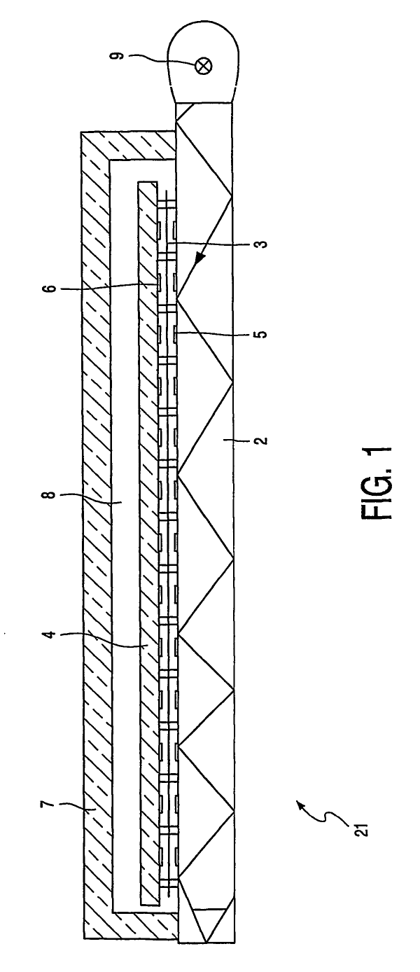

FIG. 1 shows schematically a cross sectional view of the display panel,

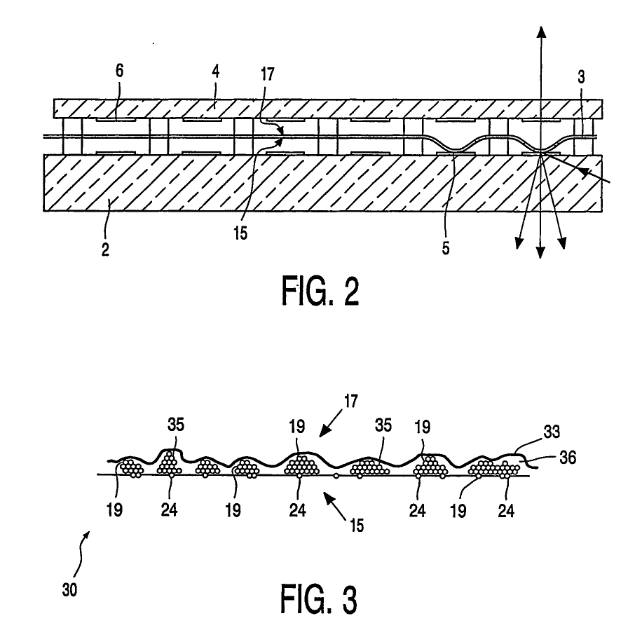

FIG. 2 shows schematically a part of the display panel,

FIG. 3 shows schematically the polymeric foil,

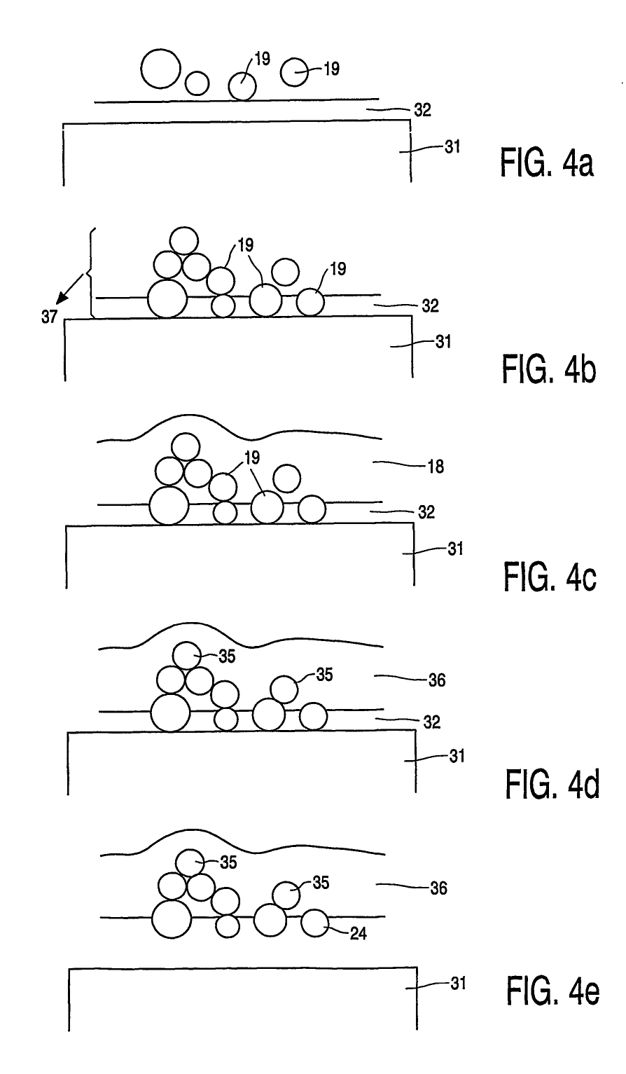

FIG. 4 shows schematically the steps in the method of manufacturing the polymeric foil,

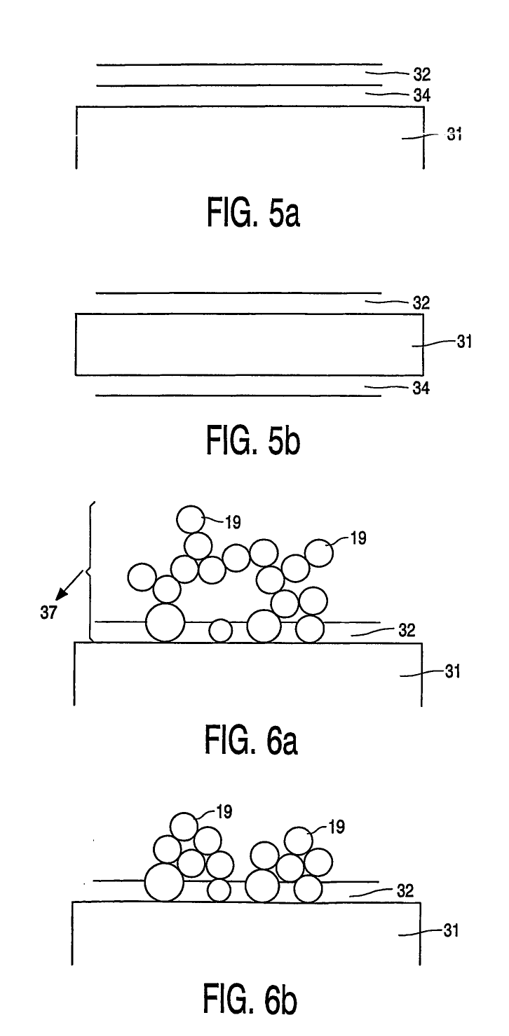

FIG. 5 shows schematically two embodiments of the substrate used containing a conductive layer,

FIG. 6 shows schematically the steps in the dipping and immersion process,

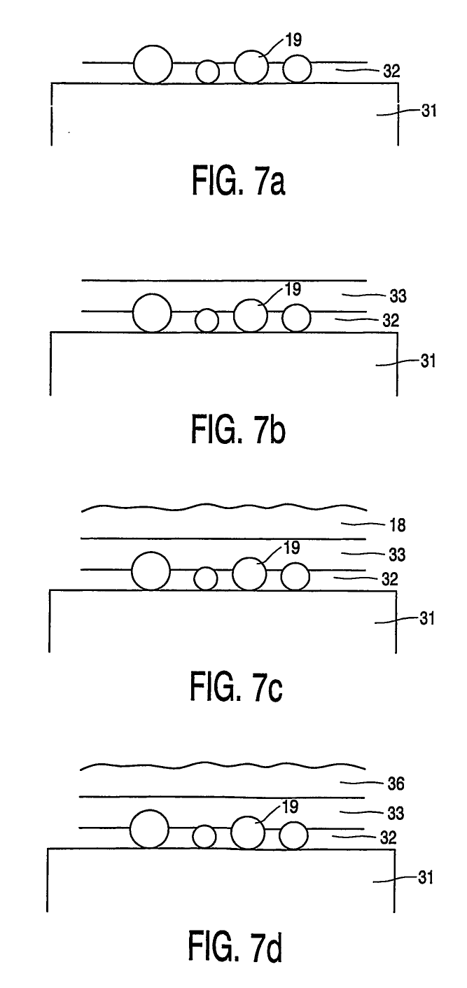

FIG. 7 shows schematically a first example of the steps of depositing a conductive layer,

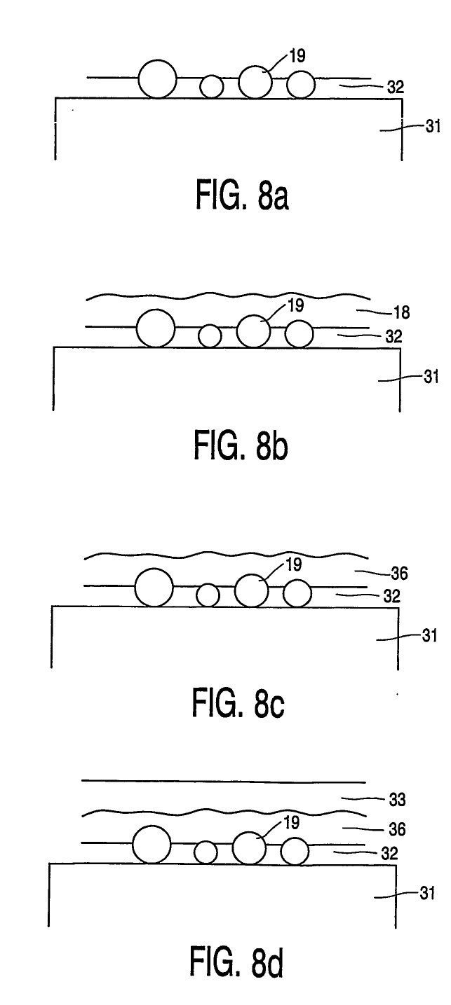

FIG. 8 shows schematically a second example of the steps of depositing a conductive layer, and

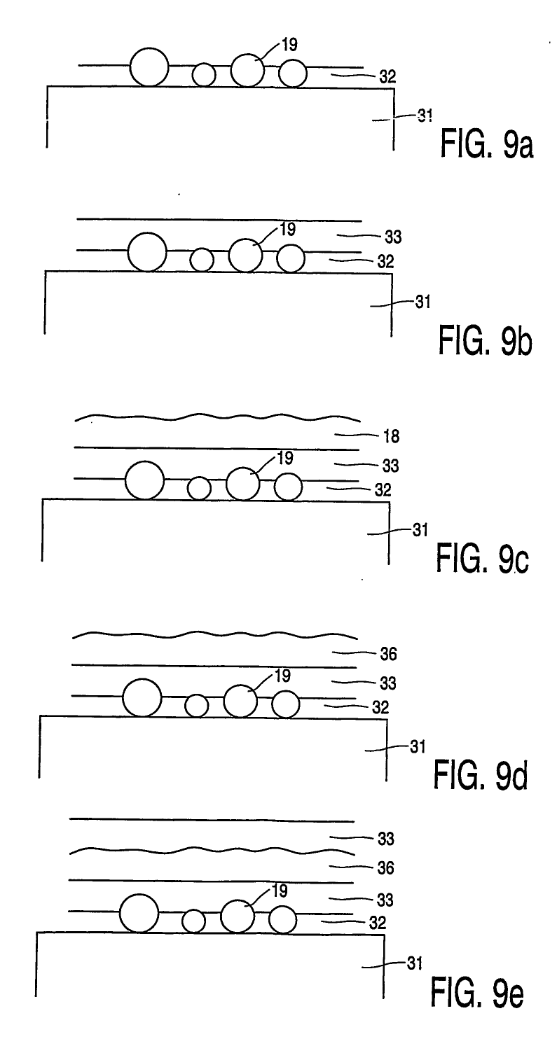

FIG. 9 shows schematically the steps of depositing two conductive layers.

The figures are schematic and not drawn to scale, and in all the figures like reference numerals refer to corresponding parts.

In FIG. 1 the display panel 21 comprises a light guide plate 2, a movable element 3 and a second plate 4. Electrodes 5 and 6 are arranged, respectively, on the sides of the light guide plate 2 and the second plate 4 facing the movable element 3. The display panel 21 comprises a covering element 7 connected to the light guide plate 2, thus forming a space 8. The display panel 21 further comprises a light source 9. Light generated by the light source 9 is coupled into the light guide plate 2. The light travels inside the light guide plate 2 and, due to internal reflection, cannot escape from the light guide plate 2 unless the situation as shown in FIG. 2 occurs. In FIG. 2 the movable element 3 locally lies against the light guide plate 2. In this state, part of the light enters the movable element 3. The movable element 3 couples the light out of the light guide plate, so that it leaves the display panel 21. The light can issue on both sides or on one side. In FIG. 2 this is indicated by means of straight arrows. Furthermore, in FIG. 2 the surface 15 of the movable element 3 facing the light guide plate 2 and the surface 17 of the movable element 3 facing the second plate 4 are indicated.

In FIG. 3 the solidified polymeric layer 36 is a glassy amorphous layer. The solidified polymeric layer 36 may also be a crystalline polymeric layer or a mixture of a glassy amorphous layer and a crystalline polymeric layer. Examples of these layers are a parylene, polymethylmethacrylate, fluoropolymer and polyimide layer. Also a cross-linked polymer layer with mechanical properties equivalent to those of a glassy amorphous or crystalline polymeric layer can be used. The thickness of the solidified polymeric layer 36 is preferably between 0.5 and 3 micrometer, with a most preferred range being between 1 and 2 micrometer.

In FIG. 3 the inorganic particles 19 are TiO2 particles. The inorganic particles 19 may alternatively be BN, ZrO2, SiO2, Si3N4 and Al2O3 particles. Some inorganic particles 19 are partly embedded in the solidified polymeric layer 36, forming inorganic protrusions 24 at the surface 15 of the polymeric foil 30 facing the light guide plate 2. In the layer shown, other inorganic particles 19 are entirely embedded within the bulk of the polymeric foil 30. These are referred to as scattering particles 35 present to scatter light out of the polymeric foil 30. It is even possible that the inorganic particles 19 forming the inorganic protrusions 24 are of another size or material than the scattering particles 35. The average size of the scattering particles 35 is preferably between 200 and 400 nm. The concentration of scattering particles 35 is in the range from 1 to 50 percent by volume of the foil. Preferably the concentration is in between 1 and 25 percent by volume of the foil. Preferably the difference in index of refraction between the solidified polymeric layer 36 and the scattering particles 35 is larger than 0.1. For smaller differences the scattering efficiency of the scattering particles 35 is rather low. Good scattering results are obtained when the index of refraction is higher than 0.5. Preferred materials for the scattering particles 35 are TiO2, BN, and Al2O3, since these materials are practically colorless. The index of refraction of the solidified polymeric layer 36 is preferably close, differing less than approximately 0.2, to the index of refraction of the material of the light guide plate 2. In this case, the reflection at the contact surface between the light guide plate 2 and the movable element 3 is small. A conductive layer 33, for instance an indium tin oxide layer, is present to apply a voltage to the movable element.

FIG. 4a shows schematically the initial situation, FIG. 4b shows the result of step a), FIG. 4c shows the result of step b), FIG. 4d shows the result of step c) and FIG. 4e shows the result of step d). In step a) the inorganic particles 19 are partly embedded into a release layer 32 which covers a substrate 31. The substrate 31 is for example a glass plate 1 mm thick. The glass plate can be cleaned before it is covered with a release layer 32. A product 37 having a rough surface is obtained. In step b) the product 37 is covered with a layer 18 of polymeric material, thereby partially embedding the inorganic particles 19 within the layer 18 of polymeric material. Subsequently, in step c) the layer 18 of polymeric material is solidified, resulting in a solidified polymeric layer 36, to obtain the polymeric foil 30. By removing the release layer 32 in step d), the polymeric foil 30, having a surface with a roughness brought about by the partially embedded inorganic particles 19, also referred to as inorganic protrusions 24, is set free from the substrate 31.

The step of embedding inorganic particles 19 partly into the release layer 32 can be performed by using the release layer 32 in a relatively soft viscous state. If the release layer 32 is not in a relatively soft viscous state already it has to be brought into a relatively soft viscous state. Softening the release layer 32 to bring it into a relatively soft viscous state can be obtained by raising the temperature of the release layer 32 above the softening temperature of the release layer 32. Another way of softening the release layer 32 to bring it into a relatively soft viscous state is by bringing the release layer 32 into contact with a material that softens the release layer 32. An example is a release layer 32 that contains organic material that is soluble in a solvent, for instance a release layer 32 containing water-soluble organic material. Then the release layer 32 can be brought into a relatively soft viscous state by exposure of the release layer 32 to moist air. Preferably, the release layer 32 contains polyvinyl alcohol, which can be deposited on the substrate 31 e.g. by spinning a polyvinyl alcohol solution in water as a polyvinyl alcohol/water film across the substrate 31 followed by drying.

The preferred thickness of the release layer 32 is in between 5 and 100 nm, with inorganic particles 19 being used having a diameter that is at least as large as the thickness of the release layer 32. Preferably, the inorganic particles 19 have a diameter between 100 and 1000 nm.

Deposition of the inorganic particles 19 can be performed from an aerosol phase. This results in a homogeneous deposition of the inorganic particles 19. Furthermore, it is an environmentally friendly process step. Electrostatic deposition of inorganic particles 19 on the release layer involves electrostatic charging of the classified inorganic particle aerosol, the transport of the charged inorganic particle aerosol towards the release layer 32, and electrostatic deposition of the charged inorganic particle aerosol onto the release layer 32 under the influence of an electrostatic potential difference between a positioned electrode and the substrate 31. In FIG. 5 a defined electrostatic potential can be applied to the substrate 31 as the substrate 31 used contains a conductive layer 34. The conductive layer 34 is present in between the substrate 31 and the release layer 32 in FIG. 5a, whereas in FIG. 5b the conductive layer 34 is present at the surface of the substrate 31 facing away from the release layer 32. Furthermore, after deposition of the inorganic particles 19 from an aerosol phase, a product 37 having a rough surface is obtained. In FIG. 6a the result of step a), and in FIG. 6b the result after a subsequent dipping process involving the immersion of the product 37 into a dipping liquid followed by the withdrawal of the product 37 from the dipping liquid are shown schematically. The process described results in a clustering of inorganic particles 19 on the release layer 32, leading to an increase of the inorganic particle 19 volume fraction in the deposited inorganic particle 19 layer. An example of a preferred dipping liquid is heptane when the release layer 32 material is polyvinyl alcohol and the inorganic particles 19 are TiO₂.

In step b) the product 37 is covered with a layer of polymeric material 18 having the inorganic particles 19 partly embedded therein. The inorganic particles 19 that are partly embedded in the release layer 32 are also partly embedded in the polymeric material. If the polymeric material is parylene, the solidifying process in step c) occurs simultaneously with the parylene deposition process in step b). If polymethylmethacrylate, some fluoropolymers, or polyimide is used as the polymeric material and applied on the product 37 from a polymer solution in a solvent as a polymer/solvent film by means of a wet coating method such as spin coating, the solidifying process occurs during the process of removing the solvent from the polymer/solvent film and during a possible additional thermal curing step at an elevated temperature.

The inorganic particles 19 that are partly embedded in the release layer 32 are also partly embedded in the solidified polymeric layer 36.

In step d) the release layer 32 is removed to obtain the polymeric foil 30 having a surface with a roughness brought about by the partly embedded inorganic particles 19. Removing the release layer 32 can be performed by dissolving the release layer 32 in a solvent. A further result is that the polymeric foil 30 is released from the substrate 31. A polyvinyl alcohol release layer 32 can be removed by dissolving in water.

In FIG. 7a the result of step a), in FIG. 7b the result of depositing a conductive layer 33, in FIG. 7c the result of step b) and in FIG. 7d the result of step c) is shown. A conductive layer 33 is deposited before a layer 18 of polymeric material is deposited. In FIG. 8a the result of step a), in FIG. 8b the result of step b), in FIG. 8c the result of step c) and in FIG. 8d the result of depositing a conductive layer 33 is shown. A conductive layer 33 is deposited after a layer 18 of polymeric material is deposited and solidified. After removing the release layer 32, both polymeric foils contain an electrode formed by the conductive layer 33. The conductive layer 33 is for instance a conductive indium tin oxide layer. The thickness is preferably about 30 nm.

In FIG. 9 both ways of depositing a conductive layer 33 are applied in one process, thereby obtaining a polymeric foil 30 having a conductive layer 33 at both surfaces. In FIG. 9a the result of step a), in FIG. 9b the result of depositing a first conductive layer 33, in FIG. 9c the result of step b), in FIG. 9d the result of step c) and in FIG. 9e the result of depositing a second conductive layer 33 is shown.

1. A method of manufacturing a polymeric foil (30) having partly embedded inorganic particles (19), the polymeric foil (30) being suitable for use as a movable element (3) in a display panel (21), comprising the steps of
a) embedding inorganic particles (19) partly into a release layer (32) which covers a substrate (31), thereby obtaining a product (37) having a rough surface,
b) covering the product (37) with a layer (18) of polymeric material, thereby partially embedding the inorganic particles within the layer (18) of polymeric material,
c) solidifying the layer (18) of polymeric material to obtain the polymeric foil (30), and
d) removing the release layer (32) to set free the polymeric foil (30) having a surface with a roughness brought about by the partly embedded inorganic particles (19).

2. A method as claimed in claim 1, characterized in that the release layer (32) used is brought into a relatively soft viscous state for embedding inorganic particles (19) partly into the release layer (32).

3. A method as claimed in claim 2, characterized in that the release layer (32) is brought into a relatively soft viscous state by bringing the release layer (32) into contact with a material that is a solvent for the release layer (32).

4. A method as claimed in claim 3, characterized in that the release layer (32) used contains water-soluble organic material.

5. A method as claimed in claim 4, characterized in that the release layer (32) is brought into a relatively soft viscous state by exposure of the release layer (32) to moist air.

6. A method as claimed in claim 1, characterized in that the release layer (32) used has a thickness between 5 and 100 nm, and the inorganic particles (19) used have a diameter larger than a thickness of the release layer (32).

7. A method as claimed in claim 1, characterized in that in step a) the inorganic particles (19) are deposited from an aerosol phase.

8. A method as claimed in claim 7, characterized in that the substrate (31) used has a conductive layer (34).

9. A method as claimed in claim 7, characterized in that between step a) and step b) the product (37) is immersed and subsequently withdrawn from a liquid for increasing the volume fraction of the inorganic particles (19) on the release layer (32).

10. A method as claimed in claim 1, characterized in that the product (37) and/or the polymeric foil (30) is covered with a conductive layer (33) prior to performing step d).
